(19) United States
(12) Patent Application Publication
(10) Pub. No.: US 2009/0005238 A1
(43) Pub. Date: Jan. 1, 2009

(54) Modified Nanostructured Titania Materials and Methods of Manufacture

(75) Inventor: Polycarpos Falaras, Attikis (GR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: NATIONAL CENTER FOR SCIENTIFIC RESEARCH DEMOKRITOS, Aghia Paraskevi Attikis (GR)

(21) Appl. No.: 12/158,027

(22) PCT Filed: Dec. 19, 2006
(86) PCT No.: PCT/IB06/04163

§ 371 Date: Jun. 18, 2008

(30) Foreign Application Priority Data
Dec. 19, 2005 (GR) 20050100617
Dec. 19, 2005 (GR) 20050100618
Dec. 19, 2005 (GR) 20050100619

(51) Int. Cl. B01J 27/02; C01G 23/053; B01J 27/18; B05D 3/02; B05D 1/18; B05D 1/40; B05D 1/02; B05D 3/12; B01J 27/24; B01J 23/00

(52) U.S. Cl. 502/200; 423/610; 502/350; 502/216; 502/208; 427/376.2; 427/356; 427/256; 427/240

(57) ABSTRACT

Provided is a method for synthesising a substantially size homogenous composition of titanium (IV) oxide (titania) nanoparticles comprising, synthesising a titania inorganic crystalline matrix within a sol gel reaction process under conditions that constrain the growth of the matrix such that a majority of the nanoparticles are of a narrow size distribution in the composition and do not exceed a maximum diameter of around 100 nm. The sol gel reaction process can occur under aqueous conditions, or within an organic polymer matrix under non-aqueous conditions. Aqueous dispersions and pastes comprising the substantially size homogenous composition of titanium (IV) oxide nanoparticles are also provided. The titanium (IV) oxide nanoparticles demonstrate improved photoactivity when exposed to UV irradiation, and can also include visible light absorbing centres such that activity is extended into the visible light range.

### FIELD OF THE INVENTION

The invention relates to compositions and methods for the production of photocatalytic and photoactive materials, most notably those made from nanoparticles of titanium (IV) oxide.

### BACKGROUND OF THE INVENTION

The chemistry of semiconductors is a research field that has been rapidly evolving. Thanks to their unique properties and their multi-functionality, semiconductors can be applied to a wide variety of industrial, energy and environmental uses.

Titanium (IV) oxide (TiO₂, also known conventionally as titania) is one of the most efficient n-type semiconductors. Titania has been particularly useful in applications where the activation of the semiconductor is based on an electromagnetic stimulus, typically via UV irradiation. Hence, titania is attributed with a range of photoactive and photocatalytic properties. Titania compositions and nanofilms can be used in the decomposition of organic pollutants in both gaseous and aqueous phases and for the destruction of bacteria (bacteriolysis) and killing other micro-organisms. For instance, suspensions of nanostructured titania powders have been utilised in UV photoreactors for water cleaning. At the same time, nanostructured titania films have been used in the conversion of solar energy to electricity and for the development of superhydrophilic surfaces.

The desirable optical and electrical properties of titanium (IV) oxide are heavily dependent upon the size of particles and their surface characteristics. Thus, considerable efforts in materials engineering focus on methods for preparing suspensions, powders and thin films from compositions of titania containing homogeneous particles, which exhibit a size variation in the region of but a few nanometers. The photocatalytic properties of titania are linked to the morphological characteristics, the size and the shape of the particles and consequently to the value of the surface area to volume ratio. Nanostructured materials with a titania particle diameter ranging between 10-100 nm exhibit enhanced activity as photocatalysts, in photoelectrode films and in superhydrophilic coatings.

Nanocrystalline titania can be prepared via a number of different techniques including: anodic oxidant hydrolysis of Ti³⁺, spray pyrolysis, chemical vapour deposition (CVD), sputtering, Langmuir-Blodgett depositions and via sol-gel based techniques. The sol-gel method is most widely used in the ceramic industries (for example: composite aluminium-silicon oxides). However, in today's environmentally sensitive world, a considerable disadvantage of the conventional sol-gel method is that it relies upon the use of organic solvents that contribute to industrial pollution and reduce the economic incentives to produce the materials at a large-scale industrial level. In fact, the reliance on these reaction conditions can mean that it is difficult to effectively achieve simultaneous control of the precursor compound (typically a metal alkoxide) hydrolysis and sol condensation reactions. In addition, subsequent control of the colloidal suspensions actually requires a high level of technical skill and this in turn requires the training and the employment of specialized staff. Therefore, it would be desirable to provide alternatives to the classical sol-gel method by developing more environmentally friendly chemical synthetic processes that reduce the amount of organic solvent required or even remove the need for organic solvents altogether.

Titania nanoparticles act as photocatalysts when exposed to electromagnetic radiation in the UV spectrum. The absorption of electromagnetic radiation by the surface of the titania material causes the formation of charge carriers (electrons or so-called holes). The strong oxidative potential of the positive holes can oxidize water to create hydroxyl radicals. They can also oxidize oxygen or other organic materials directly. This photocatalytic effect can be extended into the visible spectrum by inclusion of suitable visible light absorbing centres (sometimes referred to as doping agents) within the inorganic polymeric structure of the titania material. However, suitable inclusion and distribution of these doping agents within the crystalline titania matrix when it is in nanoparticulate form is problematic.

As discussed previously, it is the titania nanoparticles with a diameter of less than 100 nm that show the greatest efficiency for photoactivity and more specifically photocatalytic activity. Conventional sol gel synthetic techniques do not routinely provide compositions that comprise nanoparticles within this size range at a high level of size homogeneity. Very often the synthetic techniques known in the art generate a mixture of nanoparticles of many sizes that are broadly spread across the range from 1 to 100 nm and beyond. Hence, there is a need to provide processes for controlling the upper size limit of titania nanoparticles to no more than around 100 nm in diameter. Further it is desirable to provide synthetic techniques that allow for production of nanoparticle compositions of a more homogeneous size distribution, most preferably in the size range of between 5 and 20 nm. In addition, there is a need to provide homogeneous preparations of photoactive and photocatalytic nanoparticles which show catalytic activity in the visible light spectrum, preferable by effective inclusion of visible light absorbing centres into the polymeric matrix of the titania nanoparticles. It is also desirable to provide synthetic methods for preparation of titania nanoparticles and nanoparticle films and other derivatives that reduce the need for excessive use of harmful organic solvents and reagents.

Great effort has been focused on efficient production of titania thin films and coatings that demonstrate the desired photoactive properties described above. Such thin films typically consist of aggregations of titania nanoparticles. Screen-printing and doctor-blade techniques using titania nanoparticle pastes are among the most well-known processes for preparing nanocrystalline titania thin films. A significant draw back of the conventional paste preparation process is the presence of organic solvent (e.g. ethanol or cyclohexane), in which the nanoparticle components of the paste are dispersed. During the high temperature sintering steps necessary to deposit the films on a desired substrate, the presence of the organic solvent results in consumption of a large amount of oxygen necessary for the combustion of the organic load. This also results in either the emission of a significant amount of waste carbon dioxide or deposition of carbon within the film. Deposition of carbon within the titania film is a known cause of cracking and structural imperfection that results in low adhesion of the final film on the substrate.

The present invention has addressed the deficiencies in the art by providing processes for manufacturing compositions of titanium (IV) oxide (titania) nanoparticles that demonstrate significant size homogeneity, most notably to nanoparticles with a size distribution controlled to within the desired optimal UV or visible light photoactivation range. In addition, the processes provided in the invention either reduce the amount of organic solvent required or eliminate the need for organic solvents altogether. Finally, the invention provides an aqueous route to the preparation of titania nanoparticle pastes for thin film preparation, again removing the imperative for organic solvation.

These and other uses, features and advantages of the invention should be apparent to those skilled in the art from the teachings provided herein.

### SUMMARY OF THE INVENTION

A first aspect of the invention provides a method for synthesising a substantially size homogenous composition of titanium (IV) oxide (titania) nanoparticles comprising, synthesising a titania inorganic crystalline matrix within a sol gel reaction process under conditions that constrain the growth of the matrix such that a majority of the nanoparticles in the composition do not exceed a maximum diameter of around 100 nm.

The titania nanoparticles of the invention in their native form demonstrate the desired photoactivity in response to irradiation with UV light. In an embodiment of the invention a visible light-absorbing centre precursor molecule can be added to the sol gel reaction process so as to generate titania nanoparticles that demonstrate photoactivity in response to irradiation with visible light. Optionally, the visible light-absorbing centre precursor molecule comprises one or more of a suitable doping agent selected from nitrogen; sulphur; and phosphorus. In a specific embodiment of the invention, the visible light-absorbing centre precursor molecule is urea, thus, allowing the incorporation of nitrogen into the titania matrix as the doping agent.

It is preferred that the titania inorganic crystalline matrix is synthesised from an organometallic titanium precursor molecule. Suitably, the organometallic titanium precursor molecule is a titanium alkoxide, for example titanium butoxide or titanium isopropoxide. Alternatively, the titania inorganic crystalline matrix can be synthesised from a titanium halide precursor—although the halide salt is typically chosen for non-aqueous synthetic routes.

In a specific embodiment of the invention the sol gel reaction process occurs under aqueous conditions. Preferably the sol gel reaction process occurs in the presence of a complexing reagent that acts to control the growth of the nanoparticles. Suitable complexing reagents include bidentate ligands capable of complexing with a titanium (IV) metal centre, for example, acetylacetone (2,4-pentanedione), ethylene diamine tetra-acetic acid (EDTA), sodium-EDTA, disodium-EDTA, oxalic acid or oxamic acid.

In a specific embodiment of the invention the sol gel reaction process occurs under non-aqueous conditions in the presence of an organic polymer matrix. The organic polymer is suitably selected from cellulose, an ethylated derivative thereof, such as ethyl-cellulose (Ethocel®), cellulose acetate, cellulose acetate butyrate, cellulose acetate hydrogenphthalate, cellulose acetate propionate, cellulose acetate trimellitate, cellulose nitrate, cellulose cyanoethylate, and/or cellulose triacetate.

For both aqueous and non-aqueous embodiments of the invention it is preferred that the sol gel reaction process occurs under acidic conditions. More specifically, the preferred reaction conditions are where the pH of the reaction is between 1 and 4.

Typically the titania nanoparticles produced according to the method of the inventions are substantially spherical in shape.

The desired nanoparticles of the present invention are crystalline particles of titania with a diameter of less than 100 nm. The preferred nanoparticles have a hydrodynamic radius of between 0.1 and 100 nm. Typically the titania nanoparticles of the invention are spherical particles with a diameter of between 1 and 100 nm, more preferably between 1 and 70 nm, even more preferably between about 5 and about 40 nm, more preferably between about 7 and about 20 nm. In specific embodiments of the invention the nanoparticles of the invention are in a narrow size distribution centred around a diameter range of between about 10 and about 15 nm.

A second aspect of the invention provides for a composition comprising an aqueous dispersion of titania nanoparticles, characterised in that the titania nanoparticles are of a substantially homogenous size distribution. In a preferred embodiment of the invention the composition further comprises an organic binding agent. Suitably the organic binding agent is polyethyleneglycol (PEG) or a derivative thereof, such as methoxy-polyethyleneglycol.

A third aspect of the invention provides for an aqueous titania paste composition suitable for use in coating a substrate comprising titania nanoparticles that are of a substantially homogenous size distribution, and an organic binder compound. Suitably the organic binding agent is polyethyleneglycol (PEG) or a derivative thereof, such as methoxy-polyethyleneglycol.

The methods and compositions of the invention provide for substantially homogenous preparations of titania nanoparticles in which around 70%, more preferably 80% and even more preferably 90% of the nanoparticles fall within the size distributions set out above. In a specific embodiment of the invention at least 75% of the titania nanoparticles have size distribution centred around a diameter range of between about 10 and about 15 nm.

A fourth aspect of the invention provides for a method of coating a solid substrate with a photoactive layer comprising titania nanoparticles of a substantially homogeneous size distribution, comprising depositing on the substrate an aqueous composition of the type described previously, and thermally treating the coating so as to eliminate the aqueous phase and any associated organic load, and to cause sintering of the coating. In a specific embodiment of the invention the aqueous composition is deposited on the substrate via a technique selected from the group consisting of: dip coating; the doctor blade technique; spray coating; screen printing and spin coating.

In a fifth aspect of the invention a coated substrate is provided that has been coated by one of the methods described above and which comprises a thermally treated film including titania nanoparticles that are of a substantially homogenous size distribution.

### BRIEF DESCRIPTION OF THE DRAWINGS

FIG. 1 depicts the characteristic hydrodynamic radius (Rh) distribution of modified (N-containing) titania aqueous suspensions, prepared by applying the sol-gel technique in an aqueous environment. As it is shown, the hydrodynamic radius exhibits a narrow distribution with a maximum value at 10 nm.

FIG. 2. FIG. 2a presents a typical Atomic Force Microscopy (AFM) top-view picture of modified (N-containing) titania films and FIG. 2b presents the corresponding SEM image. These films were prepared applying the sol-gel method in aqueous medium utilizing acetylacetone as complexing agent and subsequent doctor-blade deposition. The films appear transparent, compact, without surface imperfections. They are composed of nanoparticles of 15 nm in diameter and are characterized by complex morphology and high surface area extension. FIG. 2c shows the characteristic XPS spectrum of the modified (N-containing) titania aqueous suspensions, prepared by applying the sol-gel technique in an aqueous environment, the Nitrogen fingerprint is present. FIG. 2d presents the characteristic UV-vis spectrum of the modified (N-containing) titania aqueous suspensions, prepared by applying the sol-gel technique in an aqueous environment. The existence of strong absorption into the visible range is clear.

FIG. 3 depicts the characteristic hydrodynamic radius (Rh) of nanostructured modified (nitrogen containing) titania colloid suspensions (sols) in the presence of cellulose polymeric matrix. Lines a, b, c and d, refer to sol colloids in which the concentration of ethyl cellulose polymer (w/v) is 1.2 (a), 2.0 (b), 0.4 (c) and 1.6 (d). It is clear that both the intensity and the distribution of the hydrodynamic radius are in close relationship to the concentration of the cellulose polymer.

FIG. 4 presents typical pictures of Scanning Electron Microscopy (SEM)-(a) and Atomic Force Microscopy (AFM)-(b), of N-doped titania films, prepared applying the sol-gel method in a polymeric cellulose matrix and subsequent doctor-blade deposition. They are composed of nanoparticles of 10-30 nm in diameter.

FIG. 5 presents the photocurrent-voltage (I-V) characteristic curve of a N-doped nanocrystalline titania film besed photosensitized cell, prepared applying the modified sol-gel method in a cellulose polymeric matrix: Solid electrolyte (redox couple I⁻/I³⁻ in PEO-TiO₂), Light power output: (70.1 mW.cm⁻²). Surprisingly the conversion efficiency as high as 4.5%

FIG. 6 shows a characteristic example of photocatalytic degradation (under UV irradiation at 350 nm) of the methyl orange azo-dye, a typical pollutant of the dye and textile industries, in the presence of an N-doped titania nanocrystalline film, prepared from a titania aqueous sol, applying the dip-coating technique.

FIG. 7 shows a characteristic example of photocatalytic degradation (under UV irradiation at 350 nm) of the methyl orange azo-dye, a typical pollutant of the dye and textile industries, in the presence of an N-doped titania nanocrystalline film, prepared applying the sol-gel method in a polymeric cellulose matrix.

FIG. 8 shows a characteristic example of photocatalytic degradation (both UV and Visible illumination) of the methyl orange azo-dye, a typical pollutant of the dye and textile industries, in the presence of an N-doped titania nanocrystalline film, prepared from a corresponding titania aqueous sol, applying the dip-coating technique.

FIG. 9 shows a characteristic example of photocatalytic degradation (under visible illumination) of the methyl orange azo-dye, a typical pollutant of the dye and textile industries, in the presence of an N-doped titania nanocrystalline film, prepared from a titania aqueous sol, applying the doctor blade technique.

FIG. 10 shows a characteristic example of photocatalytic degradation (under UV irradiation at 350 nm) of the methyl orange azo-dye, a typical pollutant of the dye and textile industries, in the presence of an N-doped titania nanocrystalline film, prepared from a nanostructured titanium aqueous paste, applied the with screen printing deposition technique.

FIG. 11 depicts the characteristic curve of the contact angle variation as a function of UV irradiation time, for a water droplet onto a TiO₂ nanocrystalline film, prepared from a titania aqueous sol, applying the dip coating technique.

FIG. 12 depicts the characteristic curve of the contact angle variation as a function of UV irradiation time, for a water droplet onto a TiO₂ nanocrystalline film, prepared applying the sol-gel method in a polymeric cellulose matrix.

FIG. 13 depicts the characteristic curve of the contact angle variation as a function of UV irradiation time, for a water droplet onto an N-doped titania nanocrystalline film, prepared from a titania aqueous sol, applying the doctor blade technique.

FIG. 14 shows a rheological diagram of nanostructured titania aqueous paste of the invention.

### DETAILED DESCRIPTION OF THE INVENTION

Prior to setting forth the invention, a number of definitions are provided that will assist in the understanding of the invention.

The term “titania” is used herein to denote titanium (IV) oxide or TiO₂.

The term “nanomaterial” is used herein to refer to a material having active properties defined by the presence within it of structures in the nanoscale range, that is, structures of a size ranging from 1 nm to a few hundred nanometres in size.

The term “nanoparticle” is used herein to refer to particulate material having a diameter in the range of about 1 nm to about 100 nm.

The term “photoactivity” is used herein to encompass the features of photocatalysis and photoelectrical activity exhibited by titania in the presence of UV or visible light (when appropriately doped). As used herein “photocatalysis” is intended to refer to the ability of a material to create an electron hole pair as a result of exposure to electromagnetic radiation and the application of this effect to catalyse chemical reactions.

Unless otherwise defined, all technical and scientific terms used herein have the same meaning as commonly understood by one of ordinary skill in the art to which this invention belongs.

Aqueous sol-gel Synthesis of Titanium (IV) Oxide Nanoparticles of Controlled Size:

The first and the most important stage of the method is the hydrolysis of the organometallic precursor compound (titanium (IV) alkoxides, according to the reaction (1):

≡Ti—OR+H₂O→≡Ti—OH+ROH (1)

wherein R=a straight or branched chain alkyl group, preferably a lower alkyl of size C₁-C₁₀. In an example of formula (1), the alkoxide is a butoxide group:

≡Ti—OCH₂(CH₂)₂CH₃+H₂O→≡Ti—OH+CH₃(CH₂)₂CH₂OH

Due to the fact that the reaction is very fast and quantitative, at first, a white, non-crystalline precipitate is formed. The hydrolysis begins after the removal of an organic group (R) and expands to the other organic groups resulting in addition of multiple hydroxyl groups. The reaction is carried out under acidic conditions, preferably between pH 1 and 4. The reaction is based on the nucleophilic attack of the titanium (IV) cations by the water molecules. The low pH of the reaction is of significance since it stabilizes the metal in a high oxidation state, inhibits the creation of imperfections inside the forming crystalline matrix and catalyses the S_{N}2 hydrolysis. It must also be pointed out that the solvent medium (water) is one of the reactants. Owing to the fact that the hydrolysis kinetics follow a second order mechanism, the rate of the reaction also depends on the water concentration, which in the present process is constant and in excess of the titanium alkoxide concentration.

The titania nanoparticles produced according to the present invention are photoactive in the UV range. However, in certain instances it is desirable to extend the photoactivity of the particles into visible light spectrum. In this case the process comprises the additional optional step of a controlled addition of a visible light-absorbing precursor to the mixture, e.g. where nitrogen is the desired doping agent urea solution is added. Indeed, the choice of a low cost, low toxicity compound such as urea as the precursor also demonstrates a significant advantage of the present invention. Other suitable light-absorbing agents include sulphur and phosphorus. Intense and constant stirring of the dispersed mixture for a few hours (˜4 hours) results in the formation of a colloidal solution. While the hydrolysis reaction is coming to its end, the condensation reactions continue to take place according to the equations:

≡Ti—OH+≡Ti—OH→≡Ti—O—Ti≡+H₂O (2)

≡Ti—OR+≡Ti—OH→≡Ti—O—Ti≡+ROH (3)

In the example of formula (1) wherein the alkoxide is a butoxide group, formula (3) is as follows:

≡Ti—OCH₂(CH₂)₂CH₃+≡Ti—OH→≡Ti—O—Ti≡+CH₃(CH₂)₂CH₂OH

These reactions lead to the formation of a three dimensional inorganic polymer. The hydrodynamic radius of the polymer is controlled so that the nanoparticles do not exceed the value of 100 nm. Consequently, as the precipitation velocity increases; the colloid becomes unstable and is finally converted to a sediment that can be recovered easily.

The nanoparticles produced according to the above reaction scheme have high homogeneity of size. Control of the nanoparticle growth phase can be achieved by inclusion of complexing reagents (e.g. a chelating agent) during the final stage of titanium alkoxide hydrolysis, when the solution becomes transparent. At this stage in the reaction, the so called ‘fining’ stage, a chelate substitute can be added in order to create a complex compound of Titanium (IV). For stereochemical and mechanistic reasons the nucleophilic attack of the alkoxides from water is hindered and this results in the kinetic control of the subsequent condensation reaction. In effect, inclusion of the complexing reagent results in the formation of a ‘molecular shield’ surrounding the titania particles and this provides the advantage of a controlled reaction. A simple but effective complexing reagent is b-diketone acetylacetone (2,4-pentanedione, also referred to as Hacac) as well as its derivatives or related compounds. Other suitable complexing reagents include ethylene diamine tetra-acetic acid (EDTA)—C₁₀H₁₆N₂O₈ or related compounds (C₁₀H₁₅N₂O₈Na, C₁₀H₁₄N₂O₈Na₂), or oxalic acid (HOOC—COOH) and oxamic acid (HOOC—CONH₂).

The decision of which complexing reagent to use is broadly based on the use of bidentate substitutes that demonstrate: a) effective complexation with transition metals, and b) the small amount of organic residue during the thermal treatment process (sintering) of any resultant films. The number of the substitutes surrounding the Ti (IV) metal centre depends on the relative concentration of the substitute and the metal concentration.

In summary, the aqueous sol-gel synthetic process of the invention described above provides substantial benefits including:
1. the selection of water as a solvent-reaction medium;
2. the optional addition of a visible light absorbing precursor; and
3. the application of a complexing reagent for the accurate control of the size of the titania nanoparticles.
   Synthesis of Titanium (IV) Oxide Nanoparticles of Controlled Size Via a sol-gel Process within a Polymer Matrix:

Efficient control of hydrolysis and condensation steps may also be achieved within an organic polymer matrix via effective control of the titania alkoxide hydrolysis step in an organic solvent and the subsequent conversion to sol. Suitable polymers may be selected from chemically modified natural polymers of the cellulose family including: cellulose, ethyl cellulose, cellulose acetate, cellulose acetate butyrate, cellulose acetate hydrogenphthalate, cellulose acetate propionate, cellulose acetate trimellitate, cellulose nitrate, cellulose cyanoethylate, and cellulose triacetate. Other suitable organic polymers include polyols of glycerine, lactose, maltose and fructose. In effect the organic polymer matrix is selected to provide a network of “honeycomb microcells” each of which operates as a unique and independent nano-reactor where reactions of hydrolysis and condensation of the precursor molecules may take place. The resultant nanoparticles are homogeneous in size and are accurately controlled by the constraints of the matrix cell size of the organic polymer.

The synthetic process is based on the nucleophilic attack of the titania precursor (alkoxide—Ti(OR)₄, or halogen salt—(TiX₄)) from Lewis bases (hydroxyl groups that bring non-bonding electrons) located on the organic polymer chain following an SN2 mechanism. Recurring hydrolysis reactions and subsequent condensation reactions lead to the formation of an inorganic polymer of titanium (IV) oxide with repetitive structural chains e.g. —O—Ti—O—Ti—O—.

In preferred embodiments of the invention, cellulose and its derivatives are considered to be particularly suitable as the choice of organic polymer. The polymers of the cellulose show a high rate of biodegradation during subsequent thermal treatments (e.g. sintering), they are environmentally friendly and they can be found in a wide variety of ethylization level. Moreover, their cost per weight unit is low.

The chemical structure of polymeric cellulose also contains an elevated percentage of accessible hydroxyls, which are able to initiate the alkoxide hydrolysis reaction. These hydroxyl groups act as initiation points for the titania polymerization following the addition of acid (acid catalyzed hydrolysis condensation). It is these hydroxyl groups that begin the hydrolysis reaction by acting as Lewis bases. The percentage of hydroxyls that are available for this purpose is reciprocally related to the ethylization level of the cellulose polymer. Since the reaction occurs under non-aqueous conditions, water molecules are not involved in the hydrolysis of the alkoxides. Thus, the role of the nucleophilic reactant originates from the polymer —OH groups. Hence, general process of the alkoxide nucleophilic attack from the cellulose polymer hydroxyl groups is an alcoholysis and the reaction is as follows:

≡Ti—OR+R′OH→≡Ti—OR′+ROH (4)

wherein R=a straight or branched chain alkyl group, preferably a lower alkyl of size C₁-C₁₀, and R′=the organic polymer chain. The hydrolysis/alcoholysis step is followed by a repetitive condensation reaction in which the inorganic titania polymer chain is grown.

The reaction is further exemplified in the schematic below, where the organic polymer is ethyl-cellulose (denoted as EC):

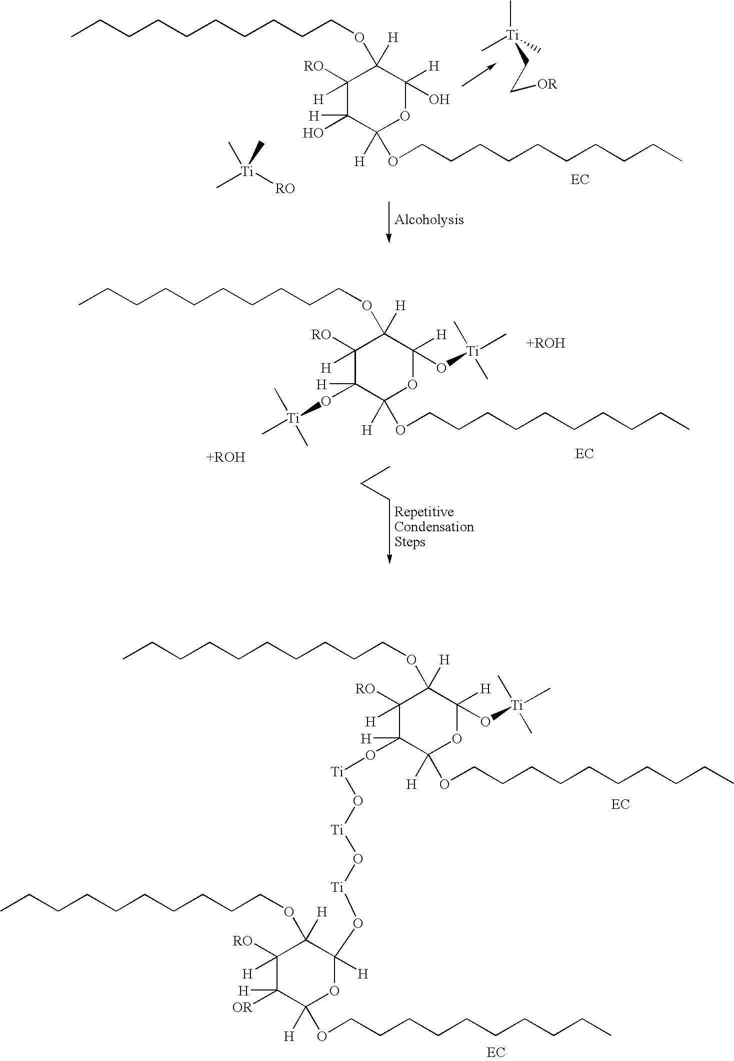

To extend the photoactivity of the particles into visible light spectrum the process includes the additional optional step of a controlled addition of a visible light-absorbing precursor to the mixture, e.g. where nitrogen is the desired doping agent urea solution is added.

According to the suggested model of reaction set out above, after the attachment of the alkoxide to the organic polymeric chain, the condensation of the inorganic semiconductor polymer with other alkoxides follows. The same pattern operates during the “classic” sol-gel method. The extension of the inorganic polymer chains takes place in three dimensional space and not only as a single, linear chain extension. The process may be terminated with the attachment of polymeric chains, depending on their relative concentration in the sol. The absence of water from this reaction and the employment of non-polar organic solvents (such as toluene), assures specific synthetic advantages for the process of the titania film preparation. Nevertheless, compared to the conventional sol-gel processes, the amount of organic solvent required in the present invention is reduced. Further, the way the organic solvent is utilised in this aspect of the present invention provides the method with a number of additional advantages such as: easy removal of reaction side-products (which are dissolved or extracted into the organic phase); improved adjustment of both viscosity of the colloid and final nanoparticle size distribution; and soft combustion conditions during the subsequent thermal treatment process as the oxygen necessary to combust the organic load is provided by the polymer.

In summary, the polymer matrix controlled sol-gel synthetic process of the invention described above provides substantial benefits including:
1. simple and mild reaction conditions;
2. ease of byproduct removal;
3. flexibility over solvent choice (i.e. organic non-polar solvent) and reduction in the amount of solvent required;
4. fine viscosity adjustment;
5. high level of control over nanoparticle size and homogeneity;
6. easy removal of organic load; and
7. option to modify photoactivity of nano-particles to respond in the visible light range.

The above two processes for production of titania nanoparticle compositions of controlled size (i.e. the aqueous titania technique and titania dispersion from a sol-gel in the cellulose polymeric matrix) may produce nanostructured, titanium (IV) oxide nano-materials, powders, and/or films, possessing complicated morphology, extended surface area and also optionally with enhanced response to the visible light spectrum. Suspensions/dispersions of the titania nanoparticles of the invention in water or other solvents can easily be deposited onto a substrate surface by using a well established thin film deposition technique or transformed to a powder, after condensation and adequate annealing. In any case, where visible light absorbing centres have been included within the titania matrix an appropriate thermal treatment (e.g. sintering) step results in the formation of N-doped nanostructured titanium (IV) oxide —TiO₂-xNx.

### Aqueous Dispersions of Titania Nanoparticles as Pastes for Use in Thin Film Coatings:

The present invention is also directed towards development of novel nanostructured titania pastes comprising the modified titania nano-particles synthesized according to either of the processes described previously. The nanoparticles in these pastes may optionally comprise visible light absorbing center precursors. The use of water in place of an organic solvent leads to a composite material that produces films that are not strained during the low temperature (100° C.) thermal process, avoiding carbon deposition. Thus, highly performing, opaque or transparent, and rough titania films can be produced, with complex morphology and high surface area, strongly adhered onto the desired substrate.

According to the invention, the novel pastes utilise water as a solvent and polyethyleneglycol (PEG) as a binder and rheological agent. During the paste preparation water is used as an easy, low cost and common solvent for the titania nanoparticles that have been previously synthesized from modified sol-gel aqueous suspensions or organic dispersions. In addition, PEG represents a low cost organic component that is highly soluble in water (at room temperature). Its presence leads to advantageous separation/binding between the titania nanomaterials and to a stronger adhesion of the paste onto the substrate. The pastes of the invention demonstrate improved rheological and viscosity properties. The PEG component is easily combusted during the thermal processing of the film so that it is not present in final product (film), and exhibits a low organic load. After the paste deposition and the formation of the relevant films with suitable thermal treatment, the organic load is removed, leaving the homogeneous titania particles to take up the open space. The thermal treatment assures the interconnection of nanoparticles, creating an extended three-dimensional semiconducting network. This process yields chemically modified titanium dioxide films possessing complicated morphology and extended photoactive surface area and high porosity.

The paste compositions of the invention, thus, continue to meet the desired goals of the invention to provide easier low cost reagents that are environmentally friendly and produce products of improved quality.

Substrate surfaces coated by the nanomaterials of the invention, obtain specific characteristics and present enhanced photocatalytic activity. Atomic force microscopy confirms the nanostructured character of the titania layers. The deposition is conveniently performed applying a plurality of suitable methods, including a laboratory modified dip-coating technique, the doctor-blade technique or screen-printing techniques. In the preferred embodiments of the invention, the diameter of the titania nanoparticles is about 15 nm and exhibits a narrow distribution. The shape of the particles is spherical. The films appear transparent, crack-free, without surface imperfections, with complex morphology and an extended surface area.

### Utility of the Nanoparticles and the Titania Films/Coatings:

The nanoparticle compositions of the invention include dispersions of the nanoparticles in liquids, preferably aqueous liquids, as well as in coatings or as films on solid substrates. The applications of these products include energy and environmental processes such as the direct conversion of solar energy into electricity, the photocatalytic degradation of organic and biological pollutants and the development of antibacterial and superhydrophilic surfaces.

Deposition of nanostructured titania films on a conductive substrate (such as conductive glass) allows for incorporation of these films into photo-electrodes for use in regenerative solar cells, particularly those that also utilise dyes as sensitizers (dye-sensitized solar cells). In such a system, visible light is absorbed by the dye, whilst the nanostructured titania semiconductor separates the electrons that are injected to the conduction band from the excited dye state. Finally, the photoelectrons are collected as photocurrent at the conductive glass substrate. By this process, a direct conversion of solar energy into electricity takes place.

The immobilization of the nanostructured titania on suitable surface substrates (e.g. slides, glasses, panels, tiles) via a thermal treatment, allows for the manufacture of photocatalytic surfaces that have the ability to completely degrade various organic pollutants in liquid/water (such as organic dyes, phenols or pesticides) or gas (aromatic hydrocarbons, harmful organics, oxides of nitrogen) that come into contact with the surface. These so-called smart materials are also have effective biocidal properties following irradiation with both ultra violet (UV) and visible light. Additionally, the deposition of the titania nanostructured films on a suitable surface can further endow it with advantageous photoinduced superhydrophilic properties. In fact, following irradiation with UV or visible light, the nanostructured modified titania surfaces obtain superhydrophilic properties. The photoinduced superhydrophilicity has been examined by the important reduction of the contact angle between a water droplet and the underlying surface, therefore the surface exhibits self-cleaning properties. It is important to notice that both the phenomena of the photocatalytic action and of the photoinduced superhydrophilicity on titania surfaces are permanent properties of the modified substrate.

The aqueous dispersions of the nanoparticles of the invention have significant utility in applications as diverse as photoactivated waste-water sterilisation and remediation. The aqueous dispersions of the nanoparticles also exhibit long shelf lives and can be used as additives to paints, treatments, render, cement, plaster and washes for use in the construction industry. In this way the photoactive catalytic properties of the nanoparticles of the invention can be applied to building surfaces and contribute to the improvement of air quality in the urban environment.

A further utility of the aqueous nanoparticle suspensions of the invention is in light mediated cleaning of instruments, articles and utensils used in, for example, food preparation. In this embodiment of the invention, the nanoparticles contain visible light absorbing centres and are dispersed in aqueous solution within a chamber that can be exposed to visible light (a photoreactor). Utensils or other articles that require cleaning can be immersed in the solution for a period of time and the visible light is turned on. The nanoparticles dispersed within the aqueous solution are activated by the visible light energy and generate biocidal hydroxyl radicals in the water that have a cleaning effect on the immersed utensils. In addition organic compounds, such as oils and grease, are photocatalytically degraded directly. A significant advantage of this embodiment of the invention, is that the aqueous nanoparticle dispersion is reusable after removal of the cleaned utensils, and reduces the need for detergents or other caustic chemicals that are damaging to the environment.

The invention is further illustrated by the following non-limiting examples.

### EXAMPLES

### Example 1

### Preparation of Modified Titania Nanostructured Materials Via a sol-gel Method in an Aqueous Medium. Combination with Deposition of an Aqueous Paste Via Dip-Coating and Doctor-Blade Techniques for the Development of Titania Nanostructured Films

A solution of the titania precursor, tetrabutylorthotitanate 15% v/v, is added to 100 mL of an acidic (below pH 4) aqueous solution (inorganic acid such as HNO₃ or organic such as HCOOH, approximately 1.5% v/v) under intense stirring. To this solution mixture, an amount of visible light absorbing precursor (i.e. urea, up to 30% w/v) is dissolved so as to enable production of an N-doped titania microparticle. The dispersed mixture is constantly stirred for around 4 hours, resulting in the formation of a colloidal solution.

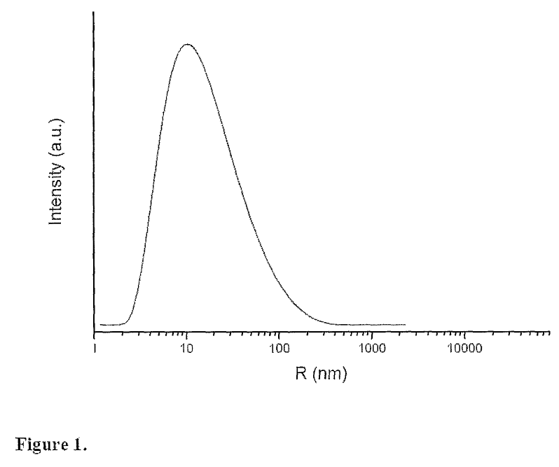

Only after the solution is refined, a second solution containing the complexing agent, acetylacetone 4% v/v, is added and the colour of the final solution turns to yellow-orange. Under continuous stirring, to the final sol an amount of a modifier-stabilizer (i.e PEG) is added. The mixture-suspension is stable for many months at room temperature, and the size distribution (hydrodynamic radius) of the nanoparticles in the solution exhibits its maximum value in the range of 7-12 nm, FIG. 1. Indeed, as can be seen from FIG. 1, the vast majority of nanoparticles synthesised fall into this narrow size distribution.

By adding the appropriate solvent and using homogenisation techniques the suspension can be introduced into spraying systems (see Okuya et al. Solar Energy Materials and Solar Cells, Volume 70, Number 4, 1 Jan. 2002, pp. 425-435 (11)). Furthermore by controlling a reduction of the aqueous component a paste will be formed, that can be easily deposited on a substrate applying conventional screen printing techniques.

The procedure for the preparation of modified (N-containing) nanostructured titania powders includes solvent evaporation followed by thermal treatment of the solid residue at temperatures in the range of 400-550° C. This procedure results to the formation of N-doped titanium (IV) oxide nano-structured powders with a specific surface area between 35-70 m²/g. In combination with stirring and hydrothermal treatment in an autoclave, addition of the powder in a mixed aqueous/organic system (a mixture of water-PEG) results in the preparation of the corresponding modified titania paste.

For the preparation of nanostructured N-doped titania films, the sol is deposited onto a glass substrate applying a dip-coating technique, following a stable withdrawal rate ranging from 1 to 10 cm min⁻¹. The resulting films are preheated for 30 minutes at 120° C., in order to remove the excess water. The next step includes progressive heat treatment from 120° C. up to 400-550° C. at a rate of 5° C./min and the films remain at the final temperature for 60 minutes, in order to effect complete combustion of the organic load and achieve the sintering of the titania nanoparticles.

The paste deposition process applying the doctor-blade technique has the following steps: a conductive glass substrate is placed on a flat surface, two adhesive tape strips are placed along the glass sides to assist in determining a desired gap-width. Subsequently, a pipette transfers a suitable quantity of paste at the edge of the free part of the substrate. The paste is then smeared along the substrate with the doctor blade twice (the first movement has an upwards direction and the second a downwards direction). The resulting films undergo the same thermal treatment as in case of the films prepared by the dip-coating technique.

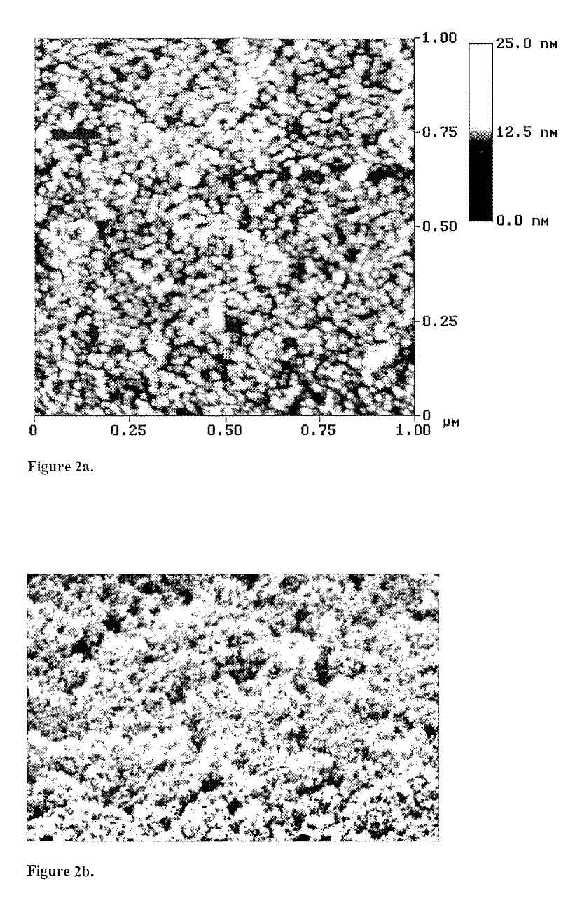

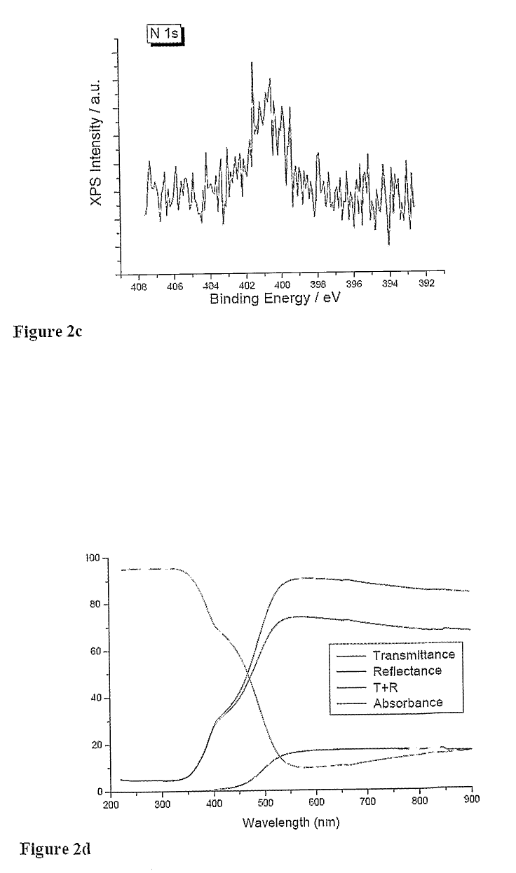

It is important to underline that independently of the deposition technique: doctor-blade; dip-coating; screen-printing, spin-coating; spray-coating; the physicochemical properties of the titania films such as the crystalline structure (anatase, rutile), the size of the nanocrystallites and of the nanoparticles, the surface morphology (roughness and fractality) nitrogen content that were prepared are related to the concentration of the initial aqueous titania suspension. This was verified applying Atomic Force Microscopy (FIG. 2a), Electron Scanning Microscopy (FIG. 2b), X-Ray diffraction and Raman Spectroscopy characterizations to the corresponding materials. The XPS (FIG. 2c) and UV-vis (FIG. 2d) spectra respectively, confirm that the dopant (N) is present in the titania matrix and this is at the origin of the important visible light absorption observed.

### Example 2

### Preparation of Modified Titania Nanostructured Materials Via a sol-gel Method in the Presence of a Cellulose Polymeric Matrix. Combination with Deposition Via the Doctor Blade Technique for the Development of Nanostructured Titania Films.

A 1% solution w/v was prepared of ethyl-cellulose dissolved in toluene at 60° C. (solution A). In a separate container, a solution of appropriate amount of the visible light adsorbing precursor urea (2.0M) and a titania precursor, titanium isopropoxide (0.5M), are mixed in toluene as the organic solvent (solution B).

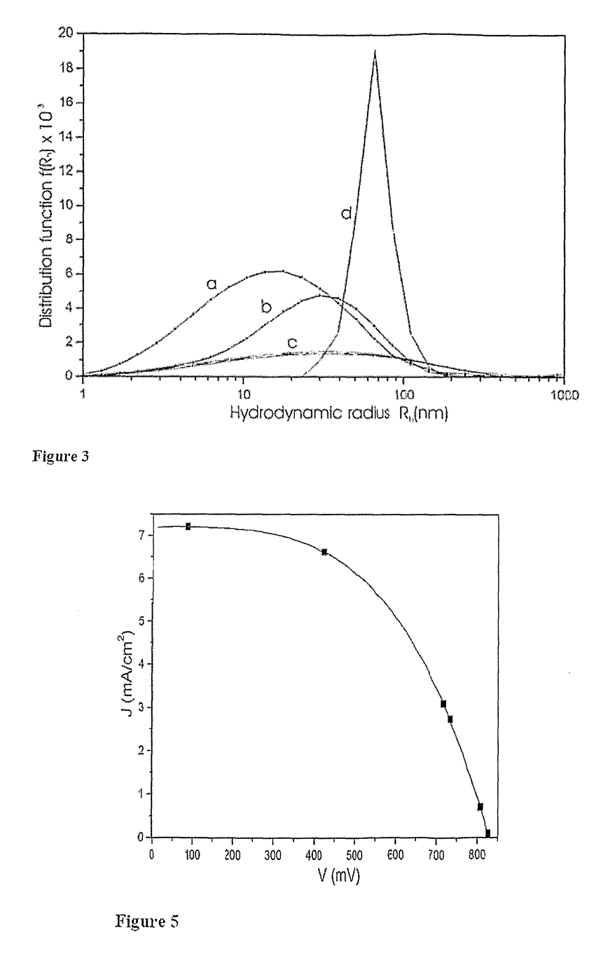

Solutions A and B are cooled to 25° C. and then they are mixed together under stirring. The final solution should have a [Ti(IV)] concentration ranging from 0.1 to 0.5M and cellulose content ranging from 0.1% w/v up to 4.0% w/v. The use of two different solutions that are mixed together is justified by the necessity for a homogeneous interaction between the precursor reagents and the cellulose polymer. Abrupt addition of the alkoxide leads to gel formation, depending on solutions' temperature. The mixed solution is heated for several hours at 50° C. in order to accelerate the alcoholysis of the alkoxide and the formation of a modified semiconducting colloid suspension (the sol). The interaction mechanism between the organic polymer matrix and the titania alkoxides during sol-gel preparation methodology and furthermore, the stability of suspensions were verified applying optical spectroscopy and viscosity measurements, whilst the measurement of hydrodynamic radius was performed applying Dynamic Light Scattering (FIG. 3).

The formation of nanostructured titania powders takes place following solvent evaporation (at mild conditions) and the thermal treatment of the solid residue from 400° C. to 550° C. for 30 minutes. Porosity studies indicate materials with high a specific surface area from 30 to 80 m²/g.

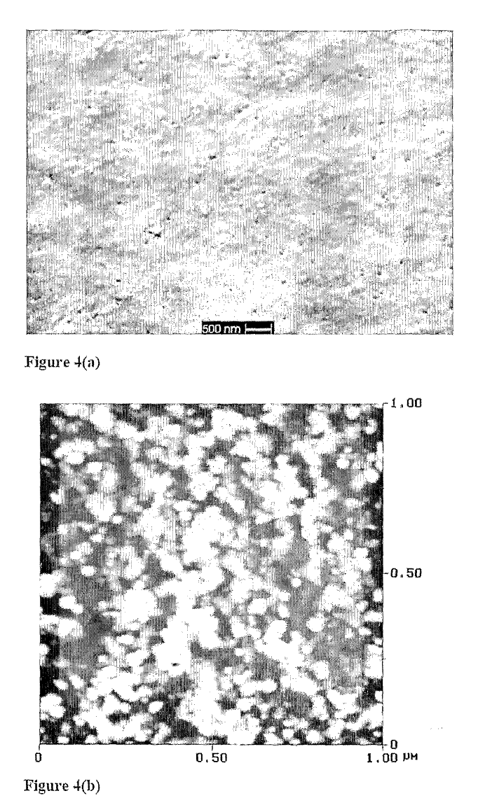

The paste deposition process applying the doctor blade technique has the same steps as in the corresponding section of example 1. The physical-chemical properties of the final modified titania films (crystalline structure (anatase or rutile), size of nanocrystallites and nanoparticles (10-30 nm), film thickness (100 nm-10 μm), surface morphology, roughness and fractal dimension are directly related to the initial concentration of the cellulose polymer. This was verified applying X-Ray diffraction, Raman Spectroscopy, Scanning Electron Microscopy (FIG. 4a) and Atomic Force Microscopy (FIG. 4b) to the corresponding materials.

Both the colloid suspensions and the resulting powders of the modified nanostructured titania are easily adaptable to spraying systems. The development of such a system includes the incorporation of a nanostructured titania dispersions with an inert gas carrier (usually nitrogen or argon) in a closed vessel under pressure. The release of the pressurized gas carrier from a special valve carries titania nanoparticles on the target. Similar N-doped nanostructured titania films can be prepared from the above mentioned materials (colloid suspensions and powders) of nanostructured titania with combined blade techniques (doctor-blade), screen printing, spin coating, spray coating and dip coating.

### Example 3

### Preparation of Nanostructured N-doped Titania Aqueous Pastes. Combination with Deposition Via Screen-Printing Technique and Doctor-Blade Techniques for the Development of Nanocrystalline Titanium Dioxide Films

The required quantity (Polyethylene glycol-PEG) or its derivative [e.g. methoxy-polyethylene glycol, activated or modified methopolyethylene glycol, ethers, polyethylene glycol) is dissolved in water at room temperature, in order to result an aqueous solution of accurate concentration (i.e. 30% w/w), Solution 1.

When the solution 1 becomes a transparent solution, an equal amount of titanium (IV) oxide nano-powder (i.e. N-doped titania nanoparticles prepared following the previous examples) is added under vigorous stirring, Suspension 2.

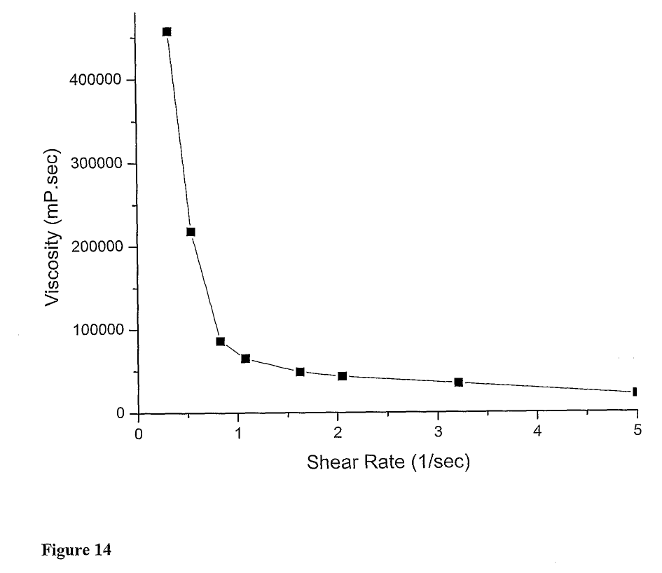

The Suspension 2 is put into a sonicator for 30 minutes and the final mixture constitutes the titania paste. The concentration of PEG and to titanium (IV) oxide range from 10% up to 50% and 50% up to 10% respectively. The molecular weight of PEG or its derivatives may be changed from 1,000 up to 20,000, the diameter of titanium (IV) oxide nanoparticles is in the region of between 10 to 100 nm. For more homogeneous results, the paste follows a hydrothermal treatment at 200° C. for 12 hours, Scheme 1. The stability of the paste is confirmed by optical spectroscopy and viscosity measurements. See FIG. 14 for a rheological diagram of the shear rate of the aqueous titania nanostructured paste of the invention.

The paste deposition process applying the screen-printing technique has the following steps: The conductive glass is placed on the suitable flat surface of a screen-printing machine (EKRA Microtronic II, Bonnigheim, Germany) and the paste is put it onto the screen (Koenen GmbH, Ottobrun, Germany) which has the following characteristics: mesh opening w=250 μm, thread diameter d=120 μm, open screen area ?o=46%, fabric thickness D=225 μm, screen dimensions=44 cm×44 cm, screen material=polyester). The paste deposition takes place with the aid of a specific plastic squeegee suitably placed on the machine, which applies onto the screen substrate a force equal to 7.5 atm. The squeegee angle with the screen is 80° and the scanner speed is 30 mm.s⁻¹. The resulting films are preheated for 15 minutes at 120° C., in order to remove the liquid solvent (water).

The next step includes progressive heat treatment from 120° C. up to the region 400-550° C. following a predetermined heating rate for approximately 15 minutes. The films remain at the final temperature for at least 30 minutes. The comparison of the experimental results shows that the physiochemical properties of the related films made by the doctor-blade method do not differ from the screen-printing ones. This proves the quality and the multifunctionality of the paste.

### Example 4

### Application of Modified Nanostructured Titania Films to Direct Conversion of Solar Energy to Electricity

Nanocrystalline solar cells are considered to be the future in the field of solar energy convertion to electricity, due to the high value of the performance-to-cost ratio that they exhibit. As far as the previous process is concerned, the role of the titania films is double: they act as substrate for chemical attachment of the dye molecular antennae (which are responsible for the absorbance of light) and additionally, they separate the electric carriers, as it constitutes the material where the transport for the injected electrons takes place.

The photosensitized cell, that was developed based on the titania films, comprises three main parts: the dye-sensitized semiconductor electrode, the electrolyte and the counter electrode. The photosensitization takes place at the nanocrystalline titania film, which was produced as described in detail during the previous examples and was deposited on conductive glass substrate. The titania film was preheated at 120° C. for one hour. After this, it is immediately dipped in an ethanol based dye solution. A redox couple (I⁻/I³⁻) is dispersed in the electrolyte and has the capability to regenerate the dye molecules, by carrying electrons from the counter electrode to the oxidized dye molecules. This cell uses a composite, solid-state polymeric redox electrolyte: (I⁻/I³⁻) at polyethylenoxide and titanium (IV) oxide (PEO-TiO₂.

The counter electrode consists of a thin layer of platinum, deposited on a conductive substrate. The cell irradiation is performed from the side of the photosensitized electrode and the current collection is made by electrical contacts attached on the two conductive substrates. In this way the characteristic photocurrent-photovoltage (I-V) diagrams were determined, and the cell parameters were estimated such as the open circuit voltage (Voc), the short circuit current (Jsc), the fill factor (FF) and the total performance of the conversion of incident light to produced electrical power (?). For the ethyl cellulose based films the resulting total conversion ratio (incident light to produced electrical power) is 4.45%, a value that is much higher than the corresponding values reported in the art for solid-state photosensitized cells.

This indicates that the film preparation according to the present invention from sols containing a modified titania (aqueous suspension and/or polymeric cellulose matrix) may contribute to the formation of a highly effective semi-conducting electrode substrate: (a) with nanostructured characteristics for unimpeded electron transport, optimum sintering and strong adhesion to the substrate, (b) with extended surface area, in order to achieve high surface concentration of chemisorbed dye molecules and (c) with optical properties that favour the extended interaction with photons (transparent titania films). The achievement of the highest ever reported total conversion efficiency (for solar cells containing solid electrolyte) underlines the advantages of the proposed technique for the preparation of the semiconducting substrate. The above-mentioned controlled sol-gel syntheses are ideal methodologies for similar applications in the field of direct conversion of solar energy.

### Example 5

### Application of Modified Titania Nanostructured Films to the Photocatalytic Degradation of Pollutants

The photocatalytic ability of modified titania nanostructured films that were deposited (from their corresponding materials described in the previous examples) onto glass substrates (microscopy glass slide or conductive glass), was estimated by the successful application of the titanium (IV) oxide nanostructured films in dye sensitized solar cells and by the decomposition of a Methyl Orange (MO) azo-dye pollutant.

The selection of MO was based on the fact that this specific azo-dye is a typical example of pollutants and is a representative compound of dyes that are widely used in the dye and textile industries. The existence of the azo-dye pollutants in the environment is connected to the appearance and the development of neoplasia (cancer) not only due to the dyes themselves but also from their benzoic derivatives.

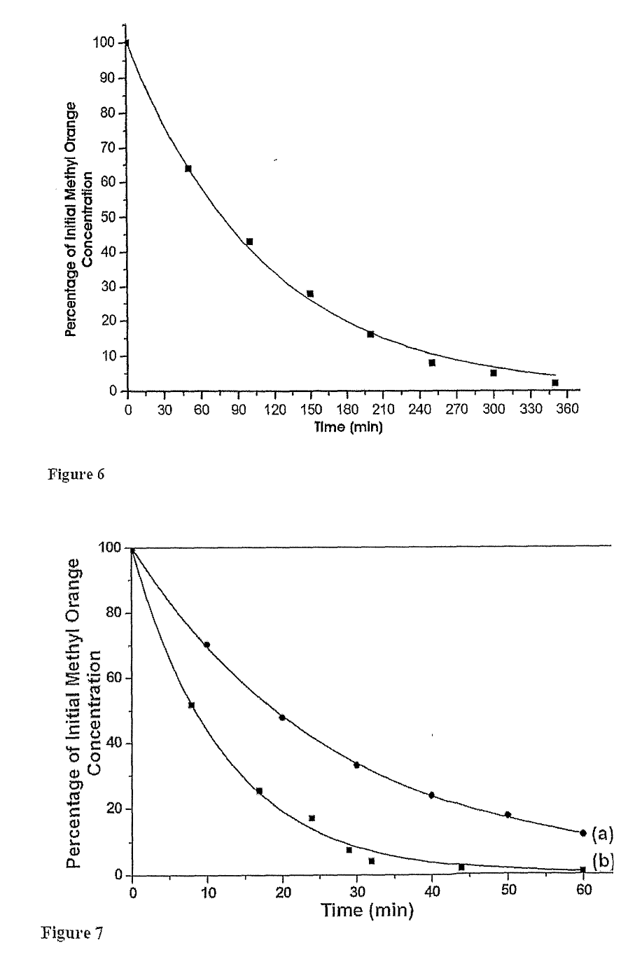

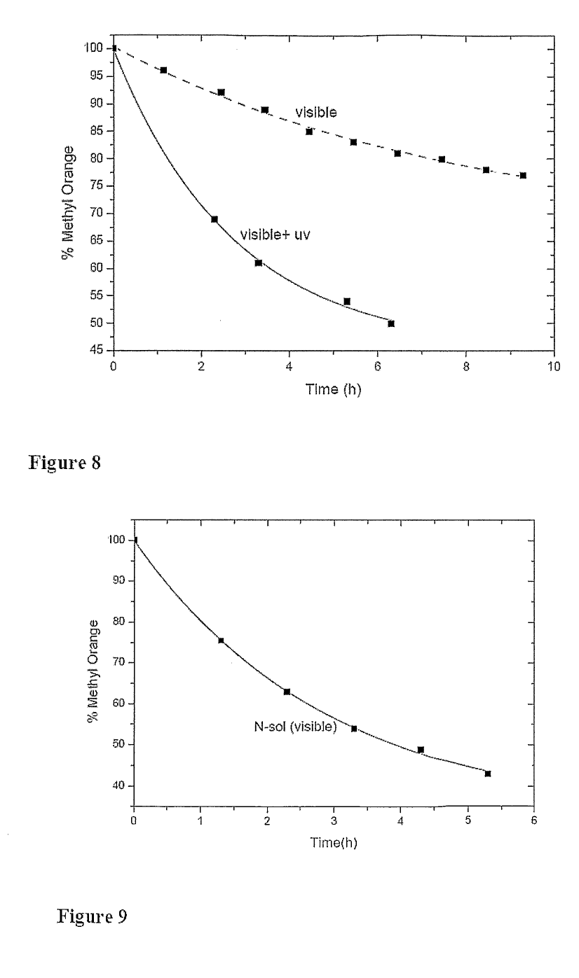

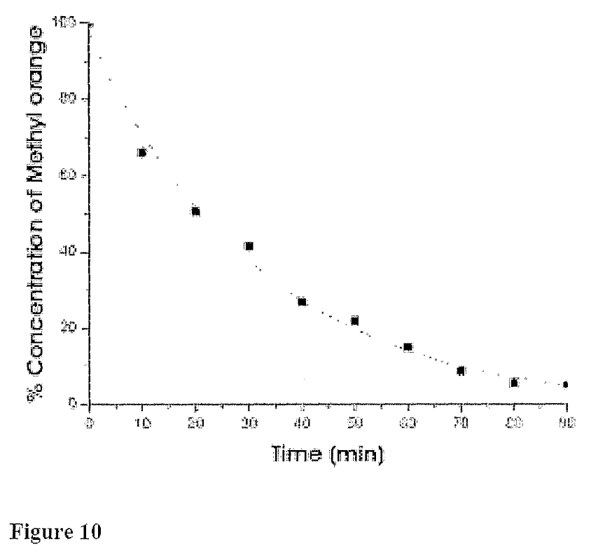

FIGS. 6-10 provide the photocatalytic degradation kinetic of this azo-dye solution (2×10⁻⁵ M), in the presence of the nanomaterial photocatalyst compositions of the invention. It must be emphasized that the degradation follows pseudo-first order kinetics, as expected from the Langmuir-Hinshelwood model, a fact that permits the determination of the reaction constants. The time needed for the total decomposition of the dye is approximately between 1 and 10 hours. It must be stressed that the photocatalytic activity remains stable for a minimum of ten (10) complete photocatalytic degradation cycles of renewing the liquid pollutant.

The N-doped materials present in the nanomaterial provide enhanced photocatalytic activity in the visible light range, in addition to the corresponding activity with UV light. Furthermore the dip-coating technique was applied to the coating of the inner surface of a pyrex glass cylindrical tube of 40 cm in length and 1 cm in diameter. The tube, after the appropriate thermal treatment, was introduced into a gas phase photocatalytic reactor. It has been thus confirmed that the films prepared from materials developed in the previous examples (aqueous titania suspensions or by a organic polymer dispersions, sols and powders) can be deposited on substrates of complex shape and dimensions (there is no restriction to flat surfaces) and show a comparable activity in the photocatalytic degradation (for both UV and visible illumination) of a series of characteristic gas pollutants, i.e.: aromatic hydrocarbons (benzene, toluene, xylene) and nitrogen oxides (NOx).

The same titania films provide, in parallel, a self-sterilizing activity, since it was proved that they are able to reduce drastically the population of bacteria and fungi in corresponding cultures. Finally, it is important to point out that the nanostructured titania powders prepared following thermal treatment of the corresponding modified titania suspensions and dispersions provided a considerably high photocatalytic activity. Thus, it has been practically proved that the environmental application of nanostructured materials (films and powders) of the present invention can be a very realistic, high performance target.

### Example 6

### Application of Modified Titania Nanostructured Films for the Development of Self-Cleaning Superhydrophilic Surfaces

A determination of the contact angles of water droplets on nanostructured titania films (that were deposited on a glass substrate) was performed in order to assess the wetting ability of the film, after prior irradiation by UV light.

Titania nanostructured thin films were deposited (using previously described deposition techniques) onto glass substrates and their hydrophilicity after illumination with soft UV (350 nm) or visible light was evaluated. For that reason the contact angle of water droplets on the films surfaces was measured. It is worth mentioning that glass substrate is usually very hydrophobic and the initial contact angle exceeds the value of 55°. On the contrary, the modified nanostructured titania substrates present a more hydrophilic character, as the contact angle is at least two times lower, a fact that is attributed to the influence of environmental lighting on the titania films.

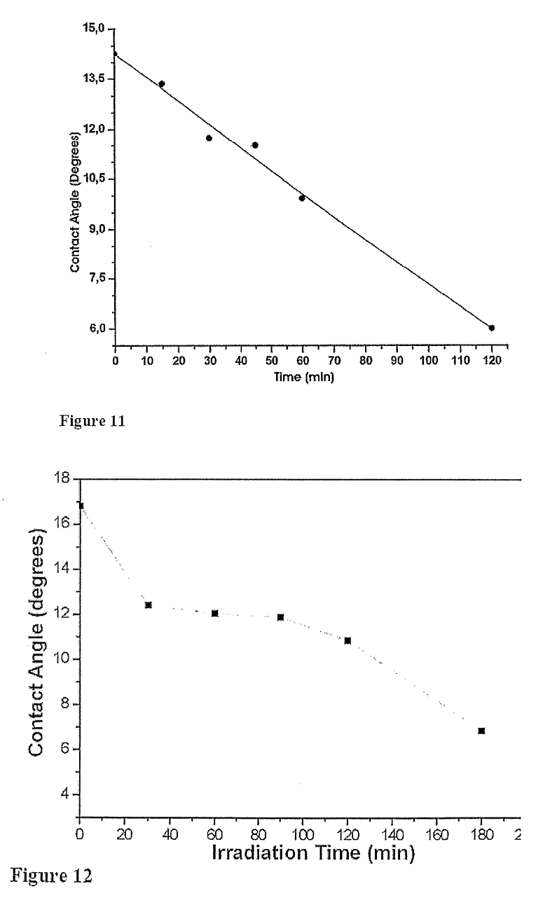

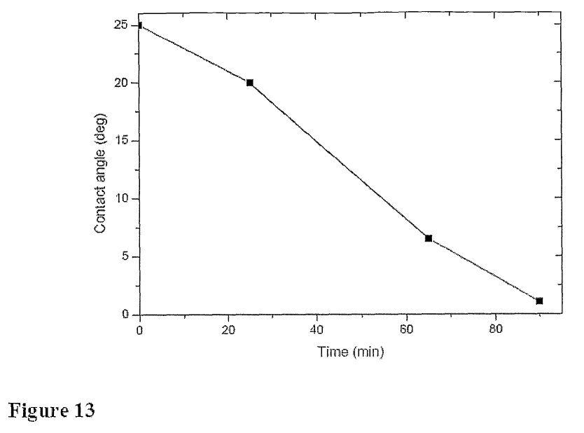

A further reduction of the contact angle can be induced by irradiating the titania film with near UV light. In particular, see FIGS. 11-13, present the dependence of the contact angle on the irradiation time for a number of modified titania thin films prepared as described above. As it is shown, the contact angle of the modified titania dioxide films with the water droplet decreases with the increase of the irradiation time. In fact, in the case of the N-doped material resulting from the aqueous suspension, FIG. 13, it is observed that the contact angle (before UV irradiation) of 25° is reduced to about 16°, after 30 minutes of UV irradiation and reduces further to 8° after 60 minutes of irradiation. When the film was irradiated for longer periods of time, it was observed that the contact angle was reduced below 1°. These results demonstrate that the nanostructured titania films modified the glass surface to provide superhydrophilic properties after its irradiation with UV light. Similar experiments showed that practically every surface (ceramic tiles and metallic plates) modified with these titania nanostructured films obtain photoinduced superhydrophilic properties.

Although particular embodiments of the invention have been disclosed herein in detail, this has been done by way of example and for the purposes of illustration only. The aforementioned embodiments are not intended to be limiting with respect to the scope of the appended claims, which follow. It is contemplated by the inventors that various substitutions, alterations, and modifications may be made to the invention without departing from the spirit and scope of the invention as defined by the claims.

What is claimed is:

1. A method for synthesising a substantially size homogenous composition of titanium (IV) oxide (titania) nanoparticles comprising, synthesising a titania inorganic crystalline matrix within a sol gel reaction process under conditions that constrain the growth of the matrix such that a majority of the nanoparticles in the composition do not exceed a maximum diameter of around 100 nm.

2. A method according to claim 1, further comprising adding a visible light-absorbing centre precursor molecule to the sol gel reaction process so as to generate titania nanoparticles that demonstrate photoactivity in response to irradiation with visible light.

3. A method according to claim 2, wherein the visible light-absorbing centre precursor molecule comprises one or more of the group selected from nitrogen; sulphur; and phosphorus.

4. A method according to claim 3 wherein the visible light-absorbing center precursor molecule is urea.

5. A method according to any previous claim, wherein the titania inorganic crystalline matrix is synthesised from an organometallic titanium precursor molecule.

6. A method according to claim 5, wherein the organometallic titanium precursor molecule is a titanium alkoxide.

7. A method according claim 6, wherein the titanium alkoxide is selected from titanium butoxide and titanium isopropoxide.

8. A method according to claim 1, wherein the titania inorganic crystalline matrix is synthesised from a titanium halide.

9. A method according to claim 1, wherein the sol gel reaction process occurs under aqueous conditions.

10. A method according to claim 9, wherein the sol gel reaction process occurs in the presence of a complexing reagent.

11. A method according to claim 10, wherein the complexing reagent is a bidentate ligand capable of complexing with a titanium (IV) metal centre.

12. A method according to claim 11, wherein the complexing reagent is selected from the group consisting of: acetylacetone (2,4-pentanedione); ethylene diamine tetra-acetic acid (EDTA); sodium-EDTA; disodium-EDTA; oxalic acid; and oxamic acid.

13. A method according to claim 1, wherein the sol gel reaction process occurs under non-aqueous conditions in the presence of an organic polymer matrix.

14. A method according to claim 13, wherein the organic polymer is selected from the group consisting of: cellulose; an ethylated derivative of cellulose; cellulose acetate; cellulose acetate butyrate; cellulose acetate hydrogenphthalate; cellulose acetate propionate; cellulose acetate trimellitate; cellulose nitrate; cellulose cyanoethylate; and cellulose triacetate.

15. A method according to claim 1, wherein the sol gel reaction process occurs under acidic conditions.

16. A method according to claim 15, wherein the pH of the reaction is between 1 and 4.

17. A method according to claim 1, wherein the titania nanoparticles are substantially spherical.

18. A method according to claim 1, wherein the titania nanoparticles have a hydrodynamic radius of between about 0.1 and about 100 nm.

19. A method according to claim 1, wherein at least 70% of the titania nanoparticles have a diameter of between 1 and 100 nm, more preferably between 1 and 70 nm, even more preferably between about 5 and about 40 nm, and most preferably between about 7 and about 20 nm.

20. A method according to claim 1, wherein at least 80% of the titania nanoparticles have a diameter of between 1 and 100 nm, more preferably between 1 and 70 nm, even more preferably between about 5 and about 40 nm, and most preferably between about 7 and about 20 nm.

21. A method according to claim 1, wherein at least 90% of the titania nanoparticles have a diameter of between 1 and 100 nm, more preferably between 1 and 70 nm, even more preferably between about 5 and about 40 nm, and most preferably between about 7 and about 20 nm.

22. A method according to claim 18, wherein at least 75% of the titania nanoparticles have size distribution centred around a diameter range of between about 10 and about 15 nm.

23. A composition comprising substantially size homogenous titania nanoparticles synthesised according to a method of claim 1.

24. A composition according to claim 23, wherein the titania nanoparticles are in aqueous dispersion.

25. A composition according to claim 23, wherein the titania nanoparticles are comprised within a sintered coating applied to a solid substrate.

26. A composition comprising an aqueous dispersion of titania nanoparticles, characterised in that the titania nanoparticles are of a substantially homogenous size distribution.

27. A composition according to claim 26, further comprising an organic binding agent.

28. A composition according to claim 27, wherein the organic binding agent is selected from polyethyleneglycol (PEG) and/or methoxy-polyethylenegycol or derivatives thereof.

29. A composition according to claim 26, wherein at least 70% of the titania nanoparticles have a diameter of between 1 and 100 nm, more preferably between 1 and 70 nm, even more preferably between about 5 and about 40 nm, and most preferably between about 7 and about 20 nm.

30. A composition according to claim 26, wherein at least 80% of the titania nanoparticles have a diameter of between 1 and 100 nm, more preferably between 1 and 70 nm, even more preferably between about 5 and about 40 nm, and most preferably between about 7 and about 20 nm.

31. A composition according to claim 26, wherein at least 90% of the titania nanoparticles have a diameter of between 1 and 100 nm, more preferably between 1 and 70 nm, even more preferably between about 5 and about 40 nm, and most preferably between about 7 and about 20 nm.

32. A composition according to claim 26, wherein at least 75% of the titania nanoparticles have size distribution centered around a diameter range of between about 10 and about 15 nm.

33. An aqueous titania paste composition suitable for use in coating a substrate comprising titania nanoparticles that are of a substantially homogenous size distribution, and an organic binder compound.

34. A composition according to claim 33, wherein the organic binding agent selected from polyethyleneglycol (PEG) and/or methoxy-polyethylenegycol or derivatives thereof.

35. A composition according to claim 33, wherein at least 70% of the titania nanoparticles have a diameter of between 1 and 100 nm, more preferably between 1 and 70 nm, even more preferably between about 5 and about 40 nm, and most preferably between about 7 and about 20 nm.

36. A composition according to claim 33, wherein at least 80% of the titania nanoparticles have a diameter of between 1 and 100 nm, more preferably between 1 and 70 nm, even more preferably between about 5 and about 40 nm, and most preferably between about 7 and about 20 nm.

37. A composition according to claim 33, wherein at least 90% of the titania nanoparticles have a diameter of between 1 and 100 nm, more preferably between 1 and 70 nm, even more preferably between about 5 and about 40 nm, and most preferably between about 7 and about 20 nm.

38. A composition according to claim 33, wherein at least 75% of the titania nanoparticles have size distribution centered around a diameter range of between about 10 and about 15 nm.

39. A method of coating a solid substrate with a photoactive layer comprising titania nanoparticles of a substantially homogeneous size distribution, comprising depositing on the substrate an aqueous composition according to claim 26, and thermally treating the coating so as to eliminate the aqueous phase and any associated organic load, and to cause sintering of the coating.

40. A method according to claim 39, wherein the aqueous composition is deposited on the substrate via a technique selected from the group consisting of: dip coating; the doctor blade technique; spray coating; screen printing and spin coating.

41. A coated substrate comprising a thermally treated film including titania nanoparticles that are of a substantially homogenous size distribution, wherein the substrate has been coated via a method according to claim 39.
